(19) United States
(12) Patent Application Publication
(10) Pub. No.: US 2011/0291508 A1
(43) Pub. Date: Dec. 1, 2011

(54) COMBINED RADIAL STABILIZER AND CENTERING ELEMENT FOR PASSIVE MAGNETIC BEARING SYSTEMS

(76) Inventor: Richard F. Post, Walnut Creek, CA (US)

(21) Appl. No.: 13/150,531

(22) Filed: Jun. 1, 2011

Related U.S. Application Data
(60) Provisional application No. 61/350,370, filed on Jun. 1, 2010.

(51) Int. Cl. H02K 7/09

(52) U.S. Cl. 310/90.5

(57) ABSTRACT

A compact magnetic bearing element for radial centering is described. At zero and low speeds, the centering occurs through mechanical contact of a rotating slotted pole structure with stretched metallic ribbons. At higher speeds, eddy currents induced in the metallic ribbons provide non-contacting centering forces. Exemplary uses for the invention are generally in rotating machinery and in flywheel energy storage systems.

### CROSS-REFERENCE TO RELATED APPLICATIONS

This application claims the benefit of U.S. Provisional Patent Application. No. 61/350,370, titled “Combined Radial Stabilizer and Centering Element for Passive Magnetic Bearing Systems,” filed Jun. 1, 2010, incorporated herein by reference.

### STATEMENT REGARDING REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

1. Field of the Invention

The present invention relates to magnetic bearing/suspension systems for the near-frictionless support of rotating elements, such as flywheels, electric motors and generators and the like. More specifically, the invention is directed to a combined radial stabilizer and centering element for passive magnetic bearing systems.

2. Description of Related Art

Motor and generator armatures, flywheel rotors, and other rotatable components have conventionally been supported and constrained against radially and axially directed forces by mechanical bearings, such as journal bearings, ball bearings, and roller bearings. Such bearings necessarily involve mechanical contact between the rotating element and the bearing components, leading to problems of friction and wear that are well known. Even non-contacting bearings, such as air bearings, involve frictional losses that can be appreciable, and are sensitive to the presence of dust particles. In addition, mechanical bearings, and especially air bearings, are poorly adapted for use'in a vacuum environment.

It is the purpose of the U.S. Pat. No. 5,495,221 to describe what can be called a “passive” magnetic bearing system. That is, a combination of stationary and rotating elements that together achieve a stable state against perturbing forces without the need for either mechanical, diamagnetic, or electronically controlled servo systems. It differs fundamentally from its prior art in that it provides a magnetic bearing system (as opposed to a magnetic bearing element) that can support a rotating object, and that achieves a dynamically stable state, even though any one of its elements, taken alone, would be incapable of stable static levitation. The virtues of the invention described therein are in the great reduction in complexity that results, together with concomitant increases in reliability, reductions in cost, and virtual elimination of power losses that it permits, relative to systems using servo-controlled magnetic bearings.

Because of these improved characteristics, magnetic bearing systems based on the teachings of the incorporated patent have uses in a variety of applications. These include, for example, electromechanical batteries (modular flywheel energy storage devices), high-speed spindles for machining, hard-disc drive systems for computers, electric motors and generators, rotating target x-ray tubes, and other devices where simplified magnetic bearing systems can satisfy a long-standing practical need for low-friction, maintenance-free, bearing systems.

As discussed in the cited patent, a simple method for providing axially directed repelling forces or radially directed (restoring) forces is to locate a conducting surface, for example made of copper or aluminum, in front of a slotted pole, relying on the repelling force from eddy-currents that will be induced in that surface as the slotted pole moves, parallel to that surface, as a result of rotation of one element relative to the other one. In this way either axially directed repelling forces or radially directed (restoring) forces can be produced that can represent the stabilizing element in an otherwise unstable or marginally stable system. FIGS. 1A and 1B are schematic representations of a slotted-pole magnetic bearing element, intended to be used with a nearby conducting plate, or with an array of inductive loops as described hereinafter. Soft iron pole faces 51 are energized by pie-shaped pieces of permanent magnet material 52, magnetized in the directions shown, to produce an intense magnetic field close to the slots 54 between the iron pole faces 51. A flux return path is provided by the circular soft iron piece 53. FIG. 1A is an end-on view of the top of the pole structure, while FIG. 1B is a side view of the various elements making up the pole structure.

FIG. 2 is a schematic end-on view of a cylindrical slotted-pole assembly having soft iron elements 60 and permanent magnet material element 61 filled with permanent magnet material. The concentrated field appears across permanent magnet material element 61. Relative rotation occurs between the pole assembly 60 and the conducting surface 62.

It is important to note that the requirements on the force derivatives represented by equations 4 and 5 of the cited patent do not necessarily imply the need for large forces to be exerted, only that the rate of change of the force should be adequately large. From the definition of K, it can be seen that if the characteristic distance of the derivative is small, then it is possible to achieve a substantial value of K even if the force involved is small. Since the characteristic distance of the slotted pole geometry is approximately equal to the gap width of the slotted pole, the use of small enough gap widths should permit stabilization (i.e., the introduction of adequate amounts of positive K values in either the radial or the axial direction) without requiring that the eddy-currents in the conducting surface to be unnecessarily large, with the accompanying large power losses.

A second, more energy efficient way, to employ slotted-pole exciters in order to generate stabilizing force derivatives is to replace the conducting surface with a surface composed of a multiplicity of conducting loops. FIG. 3 depicts schematically how the same slotted pole assembly shown in FIG. 2 could be used in conjunction with a close-packed array of circuits 70. FIG. 3 is an end view of a close-packed array of circuits 70 having a cylindrical slotted-pole assembly with permanent magnet material element 61 filled with permanent magnet material, and soft iron elements 60. Relative rotation occurs between the pole assembly and the close-packed array of circuits 70. In operation either the inner pole or the outer assembly could be rotating, depending on the application. These loops appear as an assembly of window-frame-like conducting loops, either single- or multiple-turn, using, for example, litzendraht wire to reduce high-frequency losses. As the field from the slotted-pole exciters passes by these loops, currents will be induced in them. These induced currents will in turn interact with the transverse component of the magnetic field from the slotted poles to produce a repelling force for relative displacements perpendicular to the surfaces.

The advantage of using loop circuits instead of a conducting surface to produce strong positive K values lies in the reduction in the power losses that can be achieved, as follows: The force between the slotted poles and the conductors depends on the product of the current induced and the transverse component of the magnetic field from the poles, at the conductor. However, the power dissipated by the conductors varies as the square of the current flowing in the conductor and inversely as the area of the conductor. Thus by taking advantage of flux concentration effects in the slotted poles (increasing the magnetic field), while at the same time using inductive effects to decrease the current flowing in the conductors, the product of magnetic field and current (thus the force) can be kept approximately the same. In this way it is, for example, possible to reduce the power losses associated with generating a given force or force derivative by about two orders of magnitude, relative to that associated with the employment of eddy currents in conducting surfaces. To accomplish this end the back legs of each of the loop conductors is “loaded” with ferromagnetic material in the form of laminated magnetic material or ferritic materials. FIG. 4 is a schematic side view of an inductive loaded circuit, an array of which might be used in a bearing element such as shown in FIG. 3. Wire circuit 80 (which might be made up of many turns of a wire conductor shorted together) threads through a cylinder 81 of “soft” magnetizable material, for example ferrite. Shown also on the figure are the parameters used in the theoretical expression for the force exerted on such circuits. The effect of this loading is both to decrease the current to its desired value, and to reduce the deleterious effects of mutual inductance between adjacent circuits. In the absence of this loading the effect of mutual inductance would be to perturb the currents induced in each circuit in an unfavorable direction.

It is desirable to provide novel forms and combinations of the elements of magnetic bearing systems that satisfy stability requirements under static conditions, and when the rotation speed is less than a critical value above which the magnetic system becomes dynamically stabile. The present invention provides such elements.

### SUMMARY OF THE INVENTION

A compact magnetic bearing element for radial centering is described. At zero and low speeds, the centering occurs through mechanical contact of a rotating slotted pole structure with stretched metallic ribbons. At higher speeds, eddy currents induced in the metallic ribbons provide non-contacting centering forces. Exemplary uses for the invention are generally in rotating machinery and in flywheel energy storage systems.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1A is a top view of an embodiment of a slotted pole magnetic bearing element.

FIG. 1B is a side view of the embodiment of a slotted pole magnetic bearing element of FIG. 1A.

FIG. 2 is an end view of a cylindrical slotted pole assembly.

FIG. 3 is an end view of a cylindrical slotted pole assembly with an array of circuits.

FIG. 4 is a schematic side view of an inductive loaded circuit.

FIG. 5 shows a schematic section drawing of an embodiment passive-bearing centering element of the present invention.

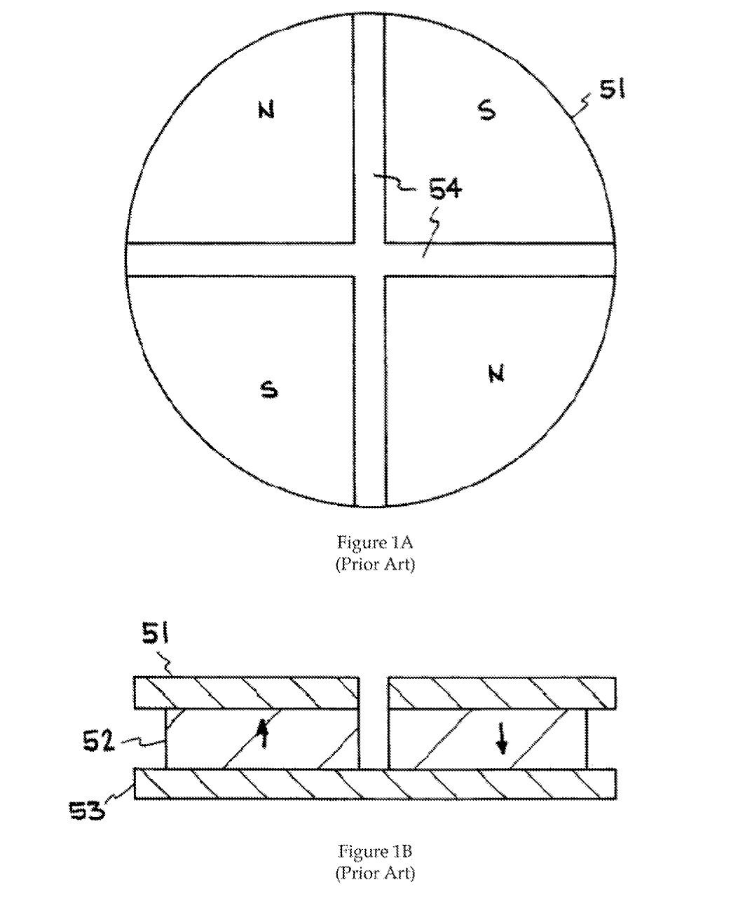

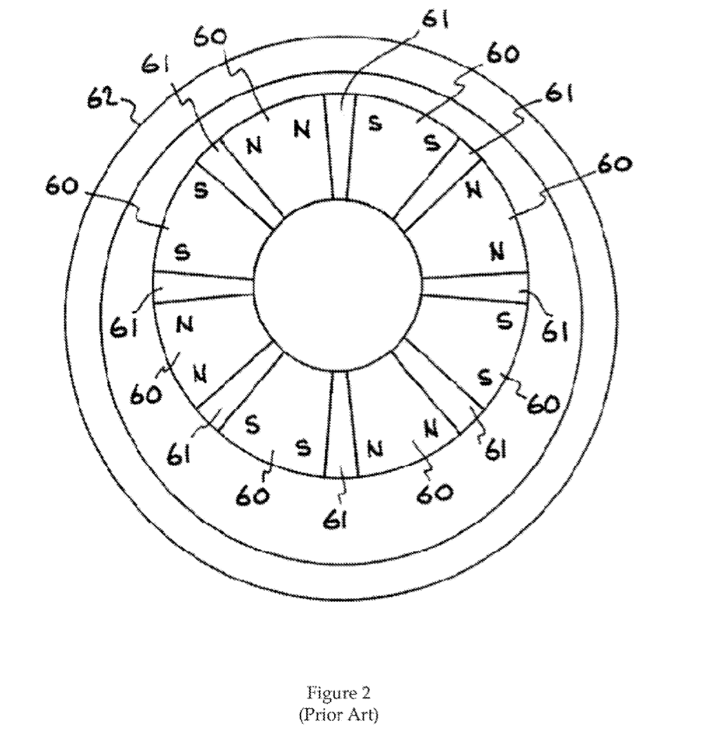

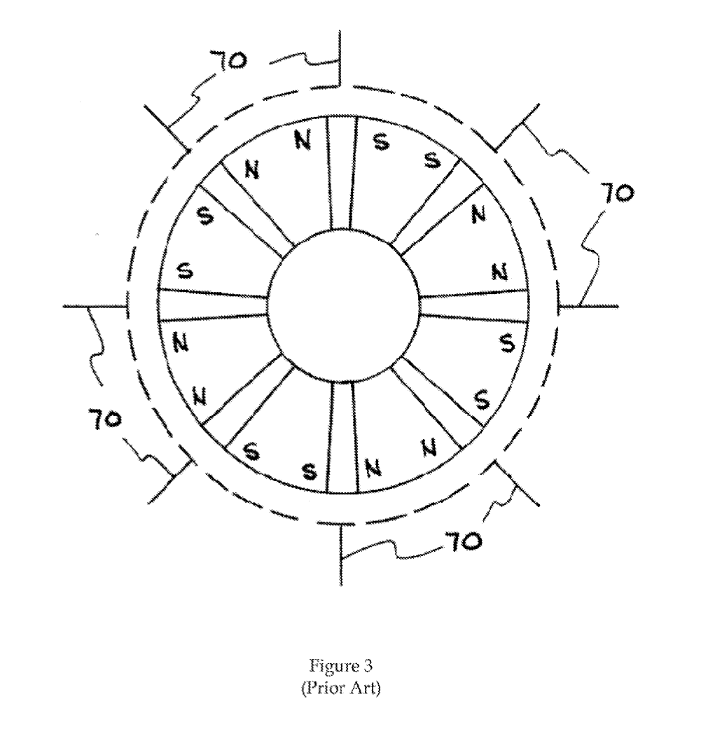

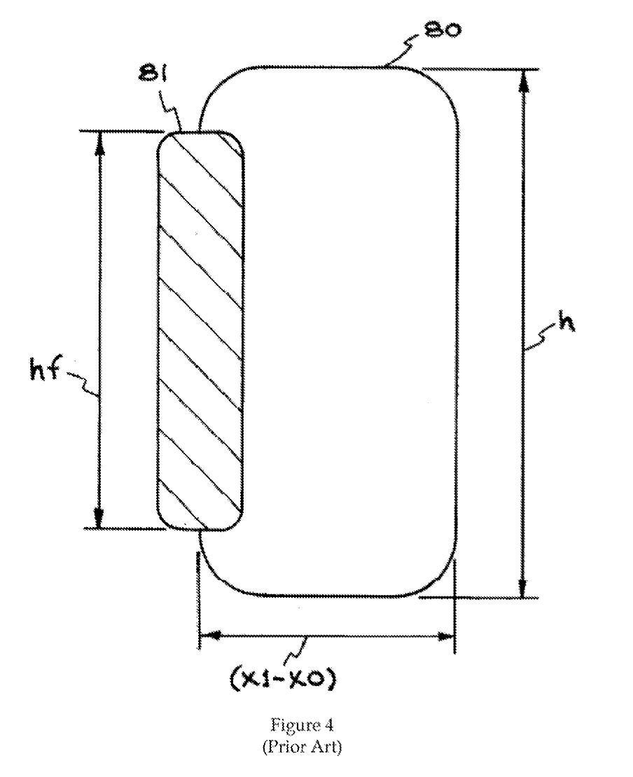

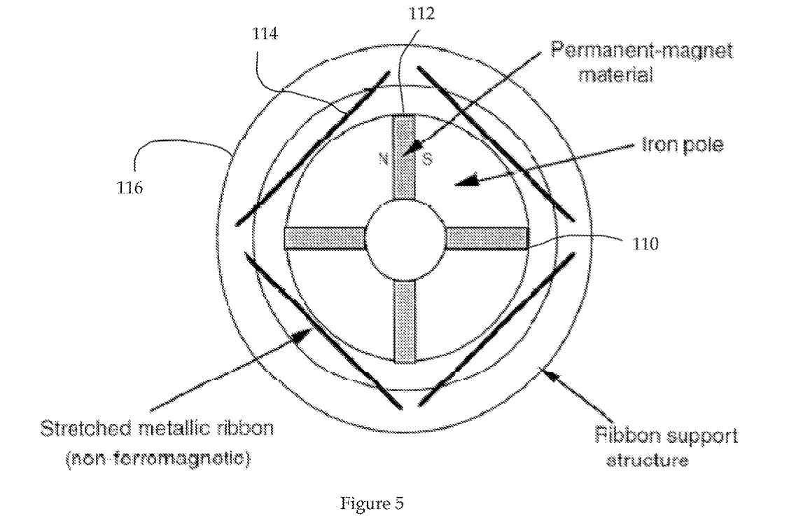

### DETAILED DESCRIPTION OF THE INVENTION

In the design of passive bearing systems such as those described in U.S. Pat. No. 5,495,221., “Dynamically Stable Magnetic Suspension/Bearing System,” incorporated herein by reference, it is desirable to provide, a means for mechanically centering a vertical-axis bearing system, while still providing centering forces at higher speeds but without mechanical contact.

As described above, non-contacting centering forces can be generated between a rotating structure made up of narrow-gapped iron poles and a conducting surface. The rotating poles generate eddy currents in the conducting surface that create a repelling force that is small for large gaps between the pole and the conducting surface, but that increases rapidly as the gap narrows between them. That is, the stiffness (negative of the force derivative) can be made to be very high for such a structure, even under situations where the restoring force itself is not large (thus the eddy-current losses are not large). Such a situation can be ideally suited to the stabilization of permanent-magnet bearing elements in a repelling mode, where the stiffness is negative (unstable) for transverse displacements, but where its magnitude is small, so that only a weak inward force is required to maintain centering, either when stationary or when rotating at high speeds.

The attached figure illustrates an embodiment of the present invention. As can be seen, it consists of a rotating slotted central pole structure 110 with permanent-magnet 112 excitation. Stretched metallic ribbons 114 are anchored in a stationary support structure 116. The ribbons are tangent to a circle that is slightly larger than the diameter of the pole structure 110. At rest, the pole structure 110 is restrained from moving transversely by contact with one of the ribbons 114. Above a (generally low) transition speed, the eddy currents generated in the ribbons by the rotation of the pole structure will provide a centering force. By adjusting the tension on the ribbons, they can be made to move slightly radially, thus reducing the level of the induced currents, and thus the power losses in the ribbons will be correspondingly reduced. For bearing systems that are only weakly unstable against transverse displacements, the eddy-current power losses can thus be made to be minimal.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
an inner rotatable magnetic pole structure;
an outer ribbon support structure concentric with said inner rotatable magnetic pole structure; and
a plurality of metal ribbons attached to said ribbon support structure such that each ribbon is tangent to or nearly tangent to said rotatable magnetic support structure.

2. The apparatus of claim 1, wherein when said rotatable magnetic pole structure is stationary or is rotating at an angular velocity that is less than a transition speed, one or more of said ribbons will provide a centering force upon said rotatable magnetic pole structure.

3. The apparatus of claim 2, wherein when said rotatable support structure is rotating at or above said transition speed, eddy currents produced in said ribbons will provide a centering force upon said rotatable magnetic pole structure.

4. The apparatus of claim 1, wherein said ribbons comprise a tension allowing them to move slightly radially, thus reducing the level of induced currents, wherein the power losses in said ribbons will be reduced.

5. The apparatus of claim 1, wherein said magnetic pole structure comprises permanent-magnet material between iron poles.

6. The apparatus of claim 1, wherein said ribbons comprises non-ferromagnetic material.

7. The apparatus of claim 1, wherein said outer ribbon support structure comprises a ring shape.

8. The apparatus of claim 1, wherein said outer ribbon support structure comprises a cylindrical shape.

9. The apparatus of claim 1, wherein said pole structure comprises a ring shape.

10. The apparatus of claim 1, wherein said pole structure comprises a cylindrical shape.

11. The apparatus of claim 1, wherein said pole structure comprises a rod or a shaft.

12. The apparatus of claim 1, wherein said pole structure is vertically oriented.

13. The apparatus of claim 1, wherein said pole structure comprises a circular diameter.

14. The apparatus of claim 1, wherein said ribbon support structure comprises a circular diameter.

15. A combined radial stabilizer and centering element for a passive magnetic bearing system, comprising:
a rotatable slotted central magnetic pole. structure;
a stationary support structure; and
stretched metallic ribbons anchored in said stationary support structure, wherein said ribbons are tangent to a circle that is slightly larger than the diameter of said pole structure.

16. The combined radial stabilizer and centering element of claim 15, wherein at rest and below a transition speed, said pole structure is restrained from moving transversely by contact with one or more of said ribbons.

17. The combined radial stabilizer and centering element of claim 16, wherein at and above said transition speed, eddy currents generated in one or more of said ribbons by the rotation of the pole structure will provide a centering force.

18. The combined radial stabilizer and centering element of claim 15, wherein said ribbons comprise a tension allowing them to move radially, thus reducing the level of the induced currents, and thus the power losses in the ribbons will be correspondingly reduced.

19. The combined radial stabilizer and centering element of claim 15, wherein said magnetic pole structure comprises permanent-magnet material between iron poles.

20. The combined radial stabilizer and centering element of claim 15, wherein said ribbons comprise a tension allowing them to move a radial distance that reduces the level of induced eddy currents, wherein power losses in said ribbons will be reduced.
